(19) United States
(12) Patent Application Publication
(10) Pub. No.: US 2005/0193770 A1
(43) Pub. Date: Sep. 8, 2005

(54) Method and apparatus for processing glass

(75) Inventors: Hans Hendrik van Schoonhoven, Prahran (AU); Hendrik Bernardus van Rhijn, Avalon (AU)

Correspondence Address: LADAS & PARRY, 26 WEST 61ST STREET, NEW YORK, NY, 10023, US

(73) Assignee: BOTTLECYCLER PTY LTD.

(21) Appl. No.: 11/035,681

(22) Filed: Jan. 14, 2005

(30) Foreign Application Priority Data
Jan. 19, 2004 (AU) 2004900234

(51) Int. Cl. C03C 15/00

(52) U.S. Cl. 65/29.12; 65/160

(57) ABSTRACT

An apparatus for processing glass objects is disclosed that comprises a chute assembly with a first opening at one end thereof for receiving glass objects and a second opening at a distal end thereof for dispensing glass cullet, a rotatable chisel assembly located substantially transversely within the chute assembly for breaking glass objects travelling through the chute assembly, drive means for causing the chisel assembly to rotate, and a controller for controlling the drive means. A method is disclosed for processing glass objects that comprises the steps of performing beneficiation to identify foreign matter amongst glass objects, breaking the glass objects to produce cullet, and identifying a portion of the cutlet that is free of the foreign matter.

### FIELD OF THE INVENTION

The present invention relates to the processing of waste glass and more particularly to the beneficiation of waste glass.

### BACKGROUND

Glass containers have traditionally been made from sand (to provide silica), soda ash (to reduce the melting point) and limestone (to increase hardness) as raw materials. More recently, however, cullet or broken glass has become a raw material for manufacturing of glass containers. Other ingredients are also used in small amounts, depending on the type of glass to be manufactured.

Bottles and jars collected in recycling schemes are manually sorted into clear, amber and green glass. This typically occurs at a beneficiation plant, where the quality of the waste glass is improved before processing. Contaminants such as metals, plastics, china, ceramics and stones are removed, and the glass is broken into cullet. The cullet is transported to glassmaking factories where it is combined with other batch materials in a furnace to manufacture new glass containers. The use of cullet, as opposed to virgin materials, has real environmental and economic benefits in terms of saving both natural resources and energy.

Small amounts of contamination can result in the rejection of tons of recycled glass. For example, ceramic material such as a piece of crockery may be sufficient to cause a ton of cullet to be returned to the recycling process or to be consigned to landfill.

The volume occupied by waste glass awaiting disposal is also a significant problem, particularly in the hospitality industry. Hotels, restaurants, pubs, public events and hospitals, to name but a few examples, accumulate a substantial volume of waste glass that requires storage space and handling. Waste glass needs to be collected frequently and sometimes at not insignificant expense.

The economic feasibility of waste glass collection and beneficiation in the hospitality industry is particularly poor due to factors such as contamination and the cost of labour and transport. This results in a low percentage of waste glass being recycled.

FIG. 1 is a flow diagram of a method for the manufacture and subsequent processing of glass containers after use. Virgin material for producing glass containers is sourced at step 110 and transported to a glass container manufacturing plant at step 115. The material is processed at step 120 and glass containers are manufactured at step 125. The glass containers are filled (e.g, at a brewery or winery) and transported to customers at step 130 and are used at step 135. An example of such use comprises the consumption of beverages in, say, a hotel pub.

The empty or waste glass containers are collected at step 140, usually from the point of use, and transported to a central location for local processing at step 145. Local processing or beneficiation typically comprises manual sorting of the glass containers into the 3 main colour groups (i.e., clear, amber and green) and removal of foreign contaminating material such as ceramics and metals. The manual processing results in a significant portion of the waste glass and foreign material (typically 40% of all waste glass) being used as landfill at step 165. The remaining portion of waste glass is transported to a plant for final beneficiation at step 150. Final beneficiation is performed at step 155, which may involve further colour sorting, removal of foreign material, prior to breaking of the sorted glass containers. Final beneficiation is typically performed automatically (e.g., by a Binder colour sorting machine and a metal detector), as opposed to manually by human beings, and results in a further portion of the waste glass (typically 10%) being used as landfill at step 165. Yet a further portion of the waste glass (typically 10%) is used in alternative applications at step 160. The remaining portion of the waste glass (typically 30%) is used as raw material for new glass container manufacture at step 125.

Current practices for processing and recycling glass containers thus involve a significant amount of handling and transportation of glass bottles to central processing depots or plants, during which some of the bottles are broken. Disadvantageously, detection of contamination and colour sorting of the glass is significantly more complex for glass cutlet than for whole bottles. Accordingly, only a relatively small portion of the waste glass can be used in the manufacture of new glass containers. A need thus exists for a method and apparatus for processing glass in a more efficient and/or cost effective manner.

### SUMMARY

According to an aspect of the present invention, there is provided an apparatus for processing glass objects, The apparatus comprises a chute assembly with a first opening at one end thereof for receiving glass objects and a second opening at a distal end thereof for dispensing glass cullet, a rotatable chisel assembly located substantially transversely within the chute assembly for breaking glass objects travelling through the chute assembly, drive means for causing the chisel assembly to rotate, and a controller for controlling the drive means.

The chisel assembly may further comprise at least one protruding portion that extends substantially longitudinally within the chute assembly from the chisel assembly towards the fist opening. The chisel assembly may further comprise a central portion mounted on a shaft disposed substantially longitudinally within the chute assembly to which the blade portions and at least one protruding portion are mounted. The protruding portion may be mounted substantially midway between the blade portions.

The apparatus may further comprise an optical detector for detecting objects inserted into the first opening. The controller in conjunction with the optical detector may be adapted to count the number of objects inserted into the first opening. The controller in conjunction with the optical detector may also be adapted to detect and count the number of glass objects of a particular glass colour inserted into the first opening.

According to another aspect of the present invention, there is provided an automated method for processing glass objects. The method comprises the steps of performing beneficiation to identify foreign matter amongst the glass objects, breaking the glass objects to produce cullet, and identifying a portion of the cullet that is free of the foreign matter.

According to still another aspect of the present invention, there is provided an apparatus for processing glass objects that comprises means for performing beneficiation to identify foreign matter amongst the glass objects and means for crushing the glass objects to produce cullet. The means for performing beneficiation may comprise an optical detector. The apparatus may further comprise means for identifying glass objects of a particular glass colour.

### BRIEF DESCRIPTION OF THE DRAWINGS

Embodiments are described hereinafter, by way of example only, with reference to the accompanying drawings in which:

FIG. 1 is a flow diagram of a method for the manufacture and subsequent processing of glass containers after use;

FIG. 2 is a flow diagram of a method for processing of glass containers after use;

FIG. 3 is a perspective view of an apparatus for on-site processing of glass containers;

FIG. 4 is a perspective view of a motor assembly for the apparatus of FIG. 3;

FIG. 5 is a perspective view of a chisel assembly for the apparatus of FIG. 3;

FIG. 6 is a block diagram of electrical circuits for controlling the apparatus 300 of FIG. 3; and

FIGS. 7 and 8 are flow charts of operation of the apparatus of FIG. 3.

### DETAILED DESCRIPTION

Embodiments of a method and an apparatus for processing glass are described hereinafter. Although the embodiments described are specifically described with reference to processing of glass bottles, it is not intended that the present invention be so limited as the principles described herein may be applicable to other kinds of glass objects and containers such as glasses, jars, vases, and fluorescent tubes.

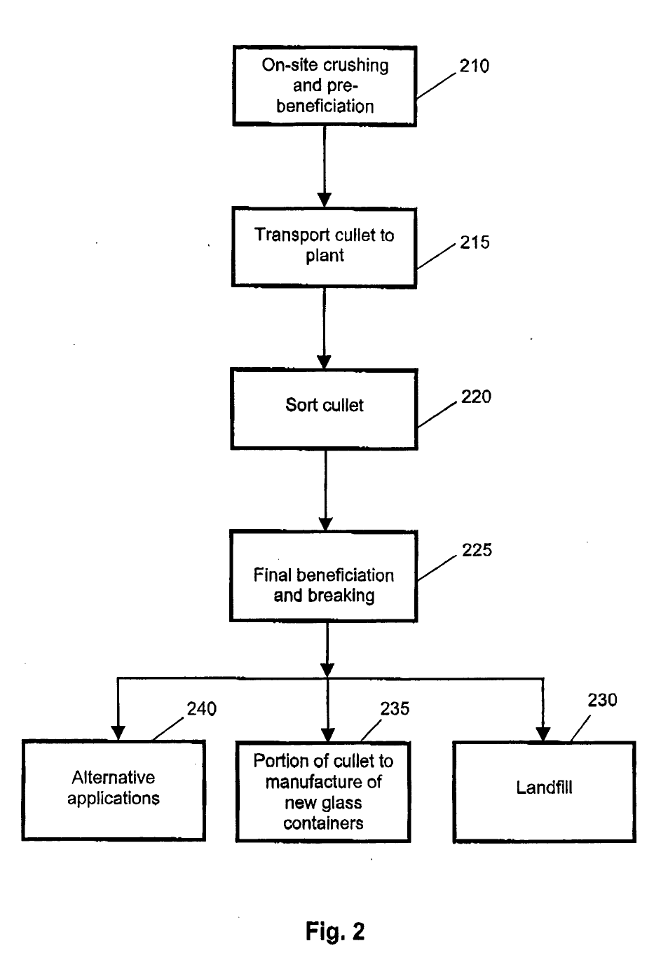

FIG. 2 is a flow diagram of a method for processing glass containers after use.

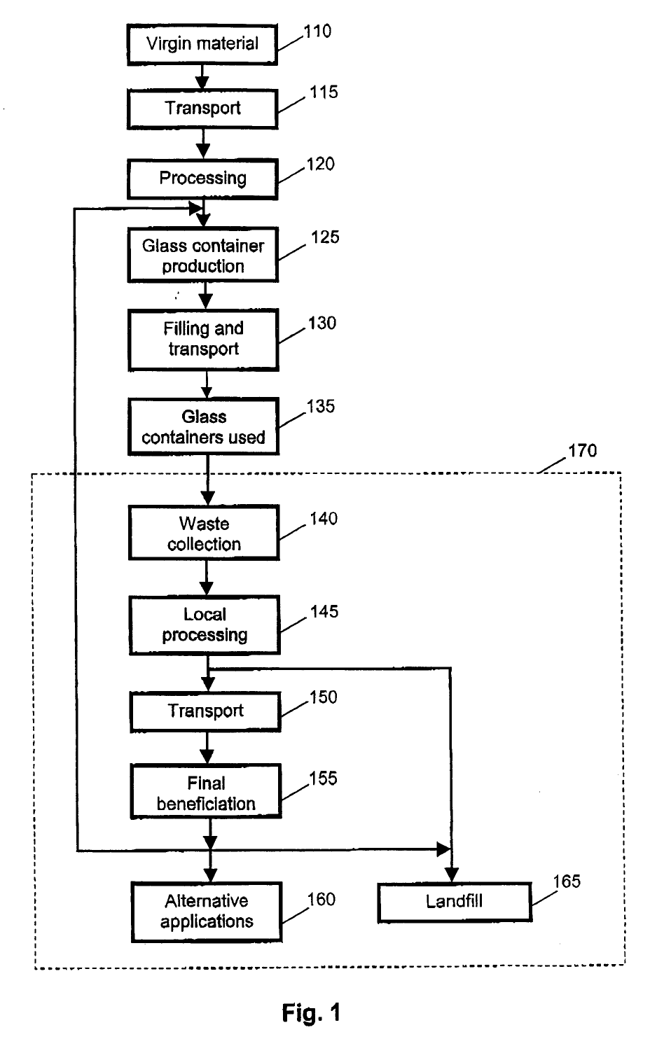

At step 210, glass containers are processed at the location or on-site where the containers were used (e.g., at a hotel, pub, hospital, etc.). An apparatus positioned either temporarily or permanently on-site may perform the processing. Alternatively, the processing may be performed on-site by a transportable apparatus mounted on a vehicle such as a truck for operation at various sites. Processing comprises pre-beneficiation to identify items that are made from or include foreign materials (i.e., ceramics and metals) and breaking of the glass containers into cullet. Items and/or portions of the cullet containing foreign materials may thus be discarded (e.g., for use as landfill, etc.). The cullet is transported to a central processing plant at step 215 to undergo final beneficiation at step 220. Final beneficiation involves colour sorting of the cullet (e.g., into the 3 main colour groups of clear, amber and green) and removal of portions of the cullet that are contaminated by foreign materials, which results in a portion of the cullet (typically 10%) used as landfill at step 230, a further portion of the cutlet being used in alternative applications (typically 10%) at step 240, and the remaining amount of cutlet (typically 80%) being used as raw material for the manufacture of new glass containers at step 235. The steps of the method shown in FIG. 2 can replace steps 140 to 165 of FIG. 1 (indicated by the box 170 formed by broken lines in FIG. 1). In this case, step 235 of FIG. 2 corresponds to step 135 of FIG. 1. The method of FIG. 2 advantageously enables a greater portion of the waste glass to be used as raw material for further glass container manufacture and reduces the amount of waste glass transportation required. More specifically, it is not required to transport whole waste glass containers.

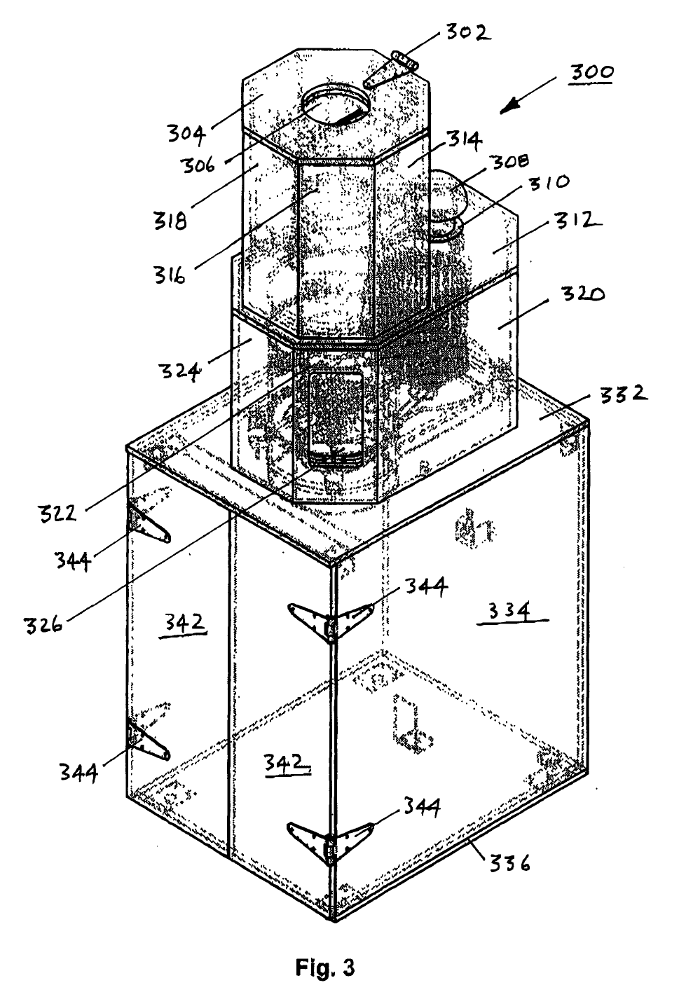

FIG. 3 shows a perspective view of an apparatus 300 for on-site processing of glass containers. On-site processing means that the apparatus 300 is deployed for pre-beneficiation and breaking of glass containers at a location where the glass containers are used and disposed of.

Glass containers may be inserted into the apparatus 300 via an opening 306 in a lid 304 of an upper chute portion defined by sides 314, 316, 318 and other sides not shown. The shape and size of the opening 306 and the lid 304 may be designed to accept typical sized glass bottles such as wine bottles but to make insertion of other objects such as ceramic cups and saucers more difficult or impossible. The lid 304 is hingedly attached to a side of the upper chute portion by means of a hinge 302. Hinged flaps are mounted on the underside of the lid 304 for obstruction of the opening 306. The flaps may be locked in a closed position by a solenoid to prevent insertion of objects into the upper chute portion when the apparatus 300 is not ready to be operated. If not locked by the solenoid, the flaps open downwards from a centre line of the opening 306 in response to insertion of an object into the opening 306. Thereafter, the flaps return to the closed position by means of a counter-weight biasing mechanism. As would be known by persons skilled in the art, other mechanisms, such as a spring-loaded mechanism, can also be practiced for the same purpose. The upper chute portion is mounted on a base plate 312, which has an aperture (not shown) through which the glass containers can pass. The base plate 312 is of substantially the same cross-section as, and acts as a top plate for, a lower chute portion defined by sides 320, 322, 324 and other sides not shown. A control panel 326 for operating the apparatus 300 is mounted on the side panel 322 of the lower chute to portion. A dome vent 308 is mounted in an aperture in the base plate 312 by means of a vent flange, typically made of foam rubber 310. The dome vent is typically made from plastic or stainless steel (other materials are also possible) and provides airflow and consequent cooling for a motor assembly located in the lower chute portion. The lower chute portion is of larger cross-section than the upper chute portion. The lower chute portion is mounted on a base plate 332 that also acts as a lid 332 of a base cabinet comprising a base plate 336, a right-side panel 334, a left-side panel (not shown), a rear panel (not shown), and left and right door panels 342 that are attached to the left-side panel (not shown) and the right-side panel 334, respectively, by means of hinges 344. The base plate 332 has an aperture (not shown) through which glass cullet can pass into the base cabinet of the apparatus 300. A bin (not shown) can be located within the base cabinet of the apparatus 300 for collection of glass cullet falling through the aperture in the base plate 332. The dimensions of the base cabinet allows insertion of a modified version of an 80-litre plastic refuse “wheelie bin” for collection of the glass cullet. The modification involves cutting the bin transversely into top and bottom portions, removing a portion of the sidewalls from at least one of the top and bottom portions, and rejoining the top and bottom portions to produce a bin of reduced height and volume. The modification reduces the volume of the bin to 60 litres with a consequent reduction in the mass of cullet the bin can hold, thus making manipulation of a full bin easier. An attachable/detachable handle extension provides a handle at approximately the usual handle height of a standard unmodified bin, which also contributes to easier manipulation of a full bin. A higher than usual handle height may be used, which advantageously assists taller users in manipulating the bin. The handle extension is required to be detached when inserting the bin into the base cabinet of the apparatus 300.

Although the lid 304 and upper and lower chute portions are of hexagonal shape and cross-section, respectively, persons skilled in the art would understand that other shapes and cross-sections may be practiced.

The apparatus 300 is generally internally insulated, and particularly the lower chute portion containing the motor assembly, which reduces the noise level generated to less than 60 dB.

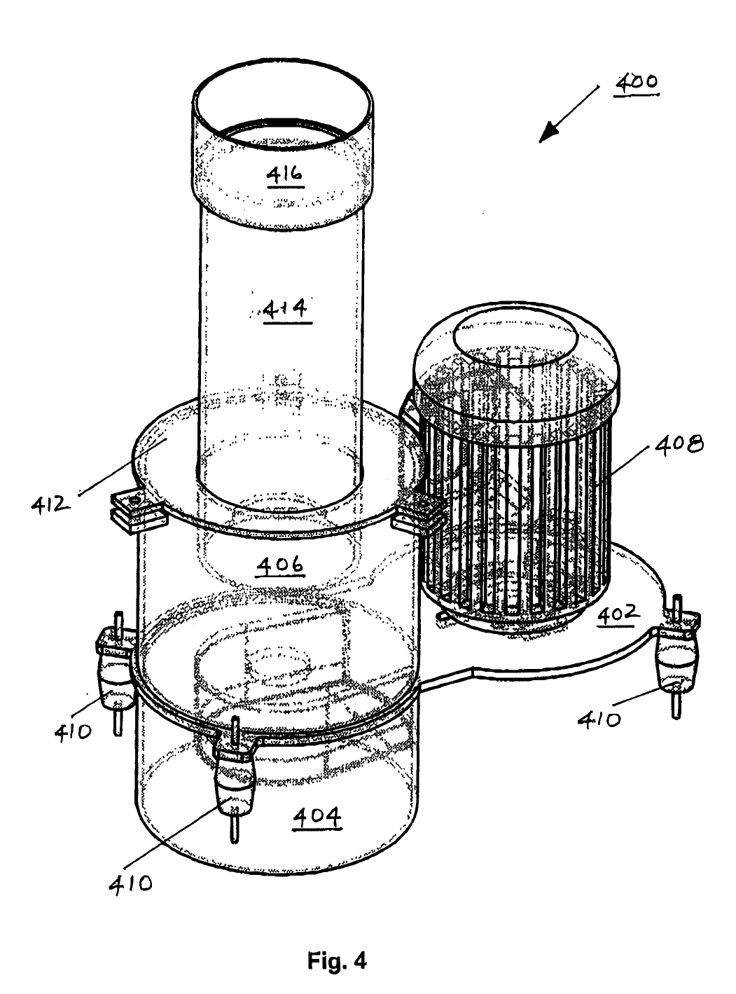

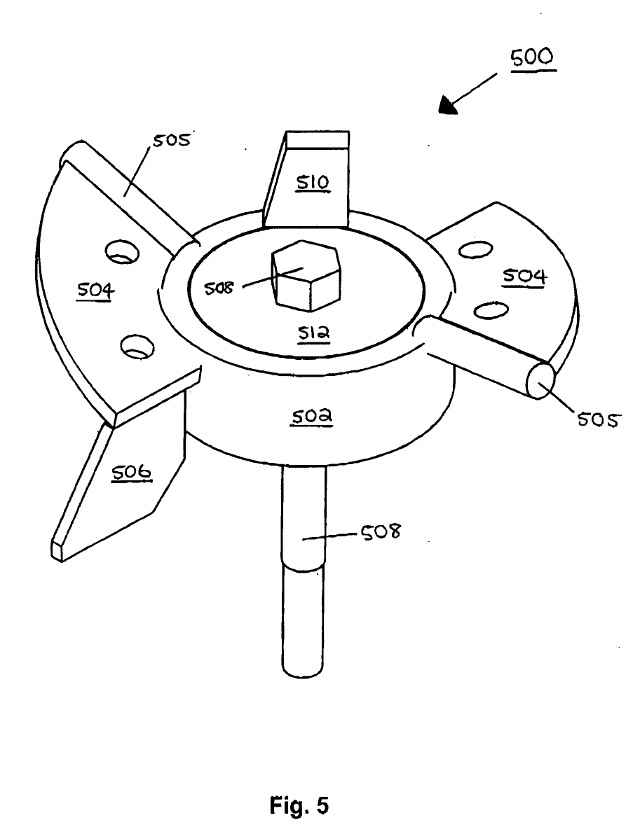

FIG. 4 shows a perspective view of a motor assembly 400 that can be mounted within the lower chute portion of the apparatus shown in FIG. 3. A motor 408 is mounted on a motor base plate 402. The motor base plate 402 is mounted on the base plate 332 by means of rubber mounts 410. The motor 408 drives a rotatable chisel assembly 500 (shown in FIG. 5 but not in FIG. 4) by means of pulley wheels, a pulley and a shaft (not shown), which are located under the motor base plate 402. The shaft connection on the driven side comprises a dog clutch, bore and key and grab screws (not shown). However, other drive train means and/or means of connection may be practiced, as would be understood by persons skilled in the art. The chisel assembly 500 is mounted within a lower portion 404 and an upper portion 406 of a chisel chamber, The lower and upper portions 404 and 406 of the chisel chamber are of circular cross section, though not necessarily, and abut the motor base plate 402 from either side. An aperture (not shown) in the motor base plate 402 is provided for mounting of the chisel assembly 500. Glass containers enter the chisel chamber via a feed pipe 414, which is located within the upper chute portion and is connected at a top end thereof to a feed pipe spacer 416 and at the bottom end thereof to the upper portion 406 of the chisel chamber. The glass containers are broken by the rotating chisel assembly 500 and the resulting cullet falls through the lower portion 404 of the chisel chamber and an aperture in the rectangular base plate 332 into the base cabinet of the apparatus 300. A rubber shield with a narrow aperture therein may be transversely mounted proximate to the top of the feed pipe 414 to prevent or at least ameliorate cullet and other material flying back up the feed pipe 414 during processing. The rubber shield also contributes to reduction of the operating noise level of the apparatus 300. In certain embodiments, an iris is used in place of the rubber shield. An iris comprises a flat member of resilient flexible material with a number of slits extending radially from the centre towards the outer perimeter of the iris, to provide resilient flaps that have to be forced open upon insertion of an object. The iris is transversely mounted within and proximate to the top of the feed pipe 414. In an optional further arrangement, a second iris is transversely mounted substantially parallel to and approximately 1 cm above the first iris. A stainless steel drip tray may be provided that surrounds the opening of the feed pipe 414. The second iris may be disposed over the top of the feed pipe 414 in the stainless steel drip tray. The irises, individually and in combination, advantageously reduce noise, prevent or reduce liquid spills in the stainless steel drip tray from entering the apparatus 300, and substantially prevent unintentional insertion of objects into the apparatus 300 by an operator. Even insertion of broken glass bottles is made more difficult. The irises are produced from Promeg (a resilient plastic material) of 0.6 mm thickness. In one particular embodiment, a circular iris has 10 flaps resulting from diametrically slitting the iris at 36° intervals.

FIG. 5 shows a perspective view of a chisel assembly 500 that can be used with the apparatus of FIG. 3. The chisel assembly 500 comprises chisel blades 504 mounted circumferentially on an annular collar 502. A circular plate 512 is mounted within the annular collar 502. A bolt 508, which serves as a shaft disposed substantially parallel to the longitudinal axis of the feed pipe 414 and/or the upper and lower chute portions (shown in FIG. 4), passes through an aperture in the centre of the circular plate 512 for purposes of driving the chisel assembly 500 via a pulley system (not shown) by the motor 408 (shown in FIG. 4). The shaft or bolt 508 is supported substantially parallel to the longitudinal axis of the feed pipe 414 and/or the upper and lower chute portions (shown in FIG. 4) by means of bearings (not shown) mounted to the upper and lower chute portions. Other forms of shaft, drive system, and shaft support means may be practiced, as would be known to persons skilled in the art.

Steel rods 505 of circular cross-sectional area are located along the glass-breaking leading edges of the chisel blades 504 to provide additional strength and reduce wear of the chisel blades 504. Sweeper portions 506, for clearing an accumulation of glass cullet directly under the chisel assembly 500, are mounted on the underside and proximate to the trailing edges of each of the chisel blades 504, The sweeper portions 506 extend substantially perpendicularly to the major surfaces of the chisel blades 504.

A protruding portion 510 is mounted on the rim of the annular collar 502, substantially perpendicularly to the major surfaces of the circular plate 512 and extending in a direction from which glass containers will arrive for breaking. The protruding portion 510 is preferably mounted proximate to the outer circumferential edge of the rim of the annular collar 502 and substantially midway between the chisel blades 504. The protruding portion 510 assists breakage of glass containers, prevents or at least ameliorates blockages in the apparatus 300, and achieves a more consistent cullet size and shape than operation without the protruding portion 510. The protruding portion 510 is shown in FIG. 5 as a quadrangular section, however, other shapes may be practiced such as a triangular section. The embodiment of the chisel assembly 500 described hereinbefore comprises a single protruding section 510, however, more than one protruding sections can be practiced.

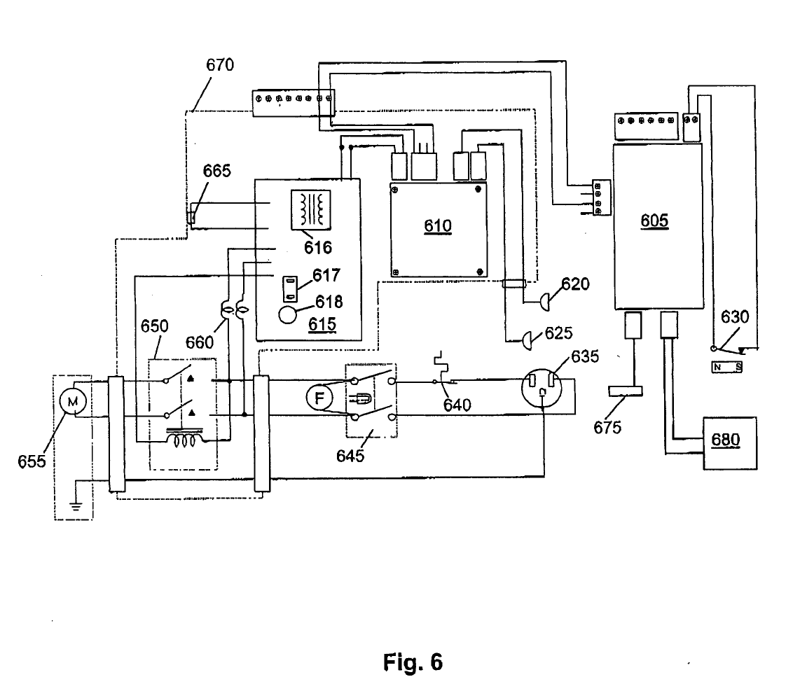

FIG. 6 is a block diagram of an electrical circuit for controlling the apparatus 300 of FIG. 3. A controller 605, including a control panel 326 mounted externally to the apparatus 300, as shown in FIG. 3, provides “START”, “STOP”, and “FORCE ON” functionality for controlling the apparatus 300, Specifically, the control panel 326 includes switches for user actuation of the foregoing functions, a green “STATUS” LED, and a visual display for user feedback, The controller 605 comprises an electronic circuit including discrete logic and/or a microprocessor that receives inputs from the switches on the control panel 326, magnetic switches 630, an ultrasonic detector unit 630, and an optical sensor unit 680.

The magnetic switches are positioned to detect the open/close status of the doors of the base cabinet, the presence or absence of the lid 304, and the open/close status of the flaps located on the underside of the lid 304 of the apparatus 300. If a door of the base cabinet is open or the lid 304 is not present, the motor 655 that drives the chisel blade assembly of the apparatus 300 is prevented from operating. On the other hand, an open flap is indicative of insertion of an object into the apparatus 300 and causes the motor 655 to operate.

The ultrasonic detector unit 610 is connected to a bin present sensor 625 and a bin full sensor 620, which detect whether a bin is present in the base cabinet of the apparatus 300 and whether a bin that is present is full, respectively, by way of distance measurement. For example, a full bin may be identified by detecting the level of cullet in the bin.

Other embodiments of the present invention may use heat and moisture resistant adjustable photo electronic detection sensors in place of or in addition to the ultrasonic bin present and bin full sensors 625 and 620, respectively. Use of a photo electronic detection sensor simplifies measurement of the level of cutlet in the bin, particularly when a non-standard bin is used.

The controller 605 also provides an output to a solenoid 675 for locking the flaps located on the underside of the lid 304 of the apparatus 300 in a closed position to prevent objects being inserted into the apparatus 300.

Operation of the motor 655 is controlled by means of the motor control unit 615, which operates a contactor relay 650 to connect or disconnect power to the motor 655. Power is provided from single-phase 230V mains via a plug socket 635, a circuit breaker 640 and a fused mains on/off switch 645. An automatic thermal overload switch may be used to prevent overheating of the motor 655 and the motor control unit 615. Accordingly, operation of the motor 655 can be prevented until a blockage or foreign material inserted into the apparatus 300 is cleared. Mains power is provided to the motor control unit 615 via a mains filter 660, a fuse 665, and a transformer 616. The ultrasonic detector unit 610, the motor control unit 615 and the main switching relay 650 are provided in a sealed unit 670. Various connectors and/or cable glands facilitate inputs and outputs to/from the sealed unit 670, A smaller cullet size is generally preferable on account of occupying a relatively smaller volume. Final beneficiation generally requires cullet size to be in the range of 10 mm to 65 mm. Additionally, certain glass manufacturers require cutlet to be less than 50 mm in size. The average size of the cullet produced is affected by the rotational speed of the chisel assembly in that a lower rotational speed results in a larger average cullet size. A typical range of rotational speed that provides a suitable average cullet size is 400 rpm to 1200 rpm. In one embodiment, the rotational speed is approximately 930 rpm.

The rotational speed of the chisel assembly may be fixed by the configuration of the motor (e.g., the number of poles) and the design of the drive train. In other embodiments, a user via the control panel 326 can control the rotational speed of the chisel assembly. For example, a 3-phase motor together with an inverter and a digital controller enable speed control of the chisel assembly.

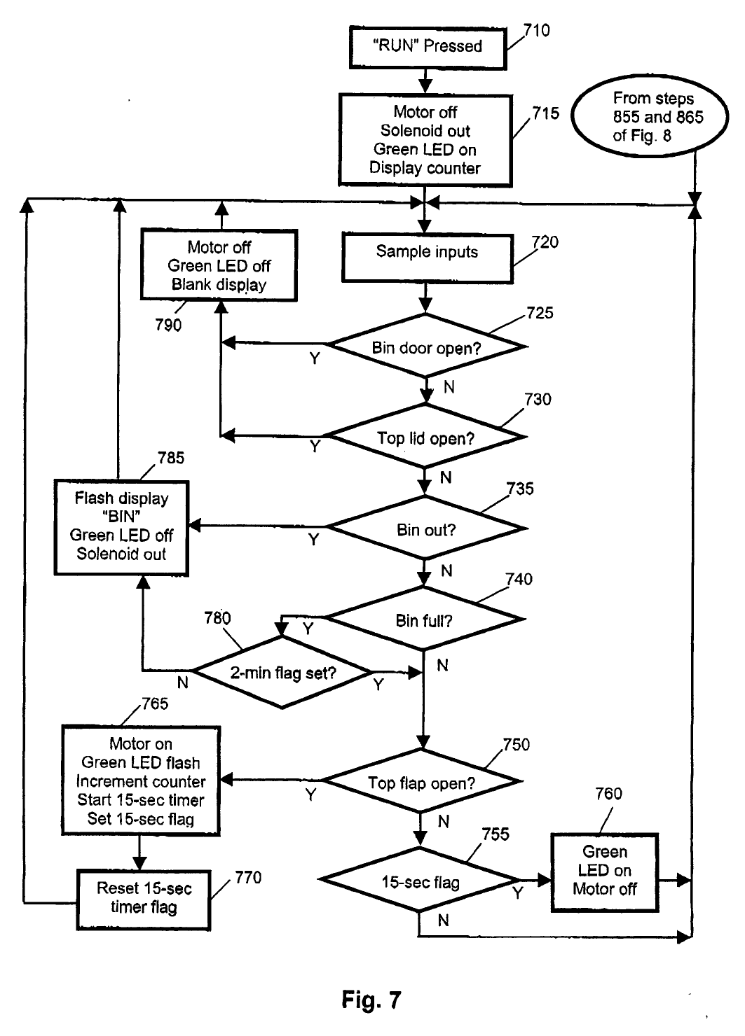

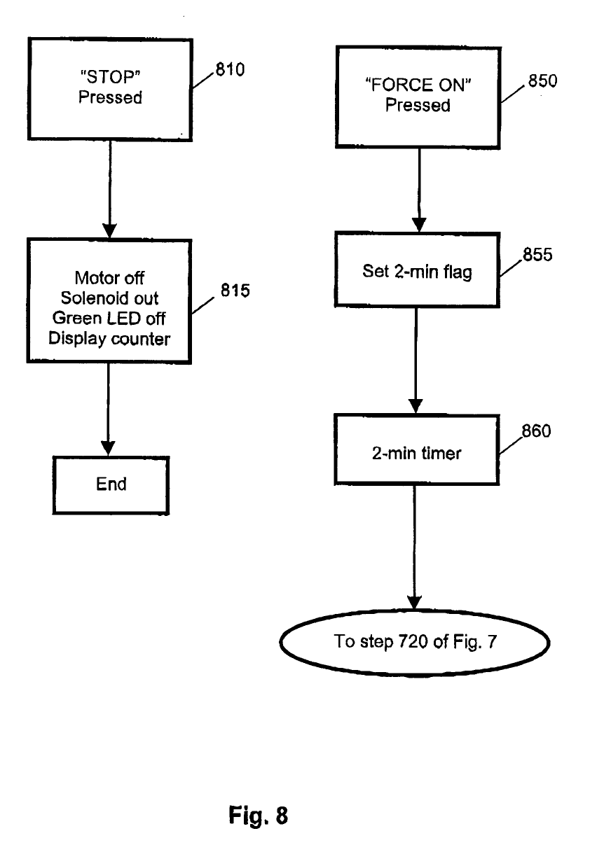

FIGS. 7 and 8 are operational flow charts for the apparatus of FIG. 3. Referring to FIG. 7, when it is detected at step 710 that the “START” button is pressed by a user of the apparatus, operation of the motor is enabled (standby mode) subject to the magnetic switches 630 that provide a safety interlock and that detect operation of the flaps, the solenoid is activated (in-position) to enable operation of the flaps, the green LED is turned on, and the number of times the flaps are activated by insertion of an item into the chute opening is accumulated and shown on the display, at step 715. At step 720, various inputs produced by sensors 620, 625 and switches 630 are sampled. A determination is made at step 725 whether the bin door is open. If yes (Y), power to the motor is removed, the green LED is turned off and the display is blanked at step 790. Thereafter, processing continues at step 720. If the bin door is not open (N), a determination is made at step 730 whether the top lid is open. If yes (Y), power to the motor is removed, the green LED is turned off and the display is blanked at step 790. Thereafter, processing continues at step 720. If the top lid is not open (N), a determination is made at step 735 whether the bin is present in the apparatus 300. If the bin is out (Y), the display is made to flash the word “BIN”, the green LED is turned off, and the solenoid is deactivated (out-position), at step 780. Thereafter, processing continues at step 720. However, if the bin is not out (N), a determination is made at step 740 whether the bin is full. If the bin is full (Y), it is determined whether a 2-minute timer flag is set at step 780. The 2-minute timer is activated when the “FORCE ON” button is pressed (see FIG. 8) and expires after a 2-minute interval. This permits 2 minutes of further operation of the apparatus 300 after a fill bin is detected. The status of the 2-minute timer flag indicates whether the 2-minute timer has expired (flag reset) or not (set). Resetting of the 2-minute timer flag occurs when insertion of a bin is detected by the bin present sensor (i.e., detection of a bin replacement). If the 2-minute timer flag has been reset (N), the display is made to flash the word “BIN”, the green LED is turned off, and the solenoid is deactivated (out) to prevent insertion of further items, at step 785. Thereafter, processing continues at step 720. If the 2-minute timer flag is set (Y), at step 780, or the bin is not full (N), at step 740, a determination is made at step 750 whether the top flap(s) is/are open. If open (Y), the motor is turned on, the green LED is made to flash, the counter is incremented, a 15-second timer is activated, and a 15-second timer flag is set, at step 765, The 15-second timer provides a fixed interval of operation of the apparatus 300 after insertion of an object into the apparatus 300. The 15-second timer flag indicates whether the 15-second timer has expired (flag reset) or not (set). The 15-second timer flag is reset after a 15-second interval at step 770 and processing continues at step 720. If the top flap is not open (N), a determination is made at step 755 whether the 15-second timer flag has been reset. If not (N), processing continues at step 720. However, if the 15-second timer flag has been reset (Y), the motor and the green LED are turned off at step 760, Thereafter, processing continues at step 720.

Turning now to FIG. 8, if at any stage the “STOP” button is pressed at step 810, the motor is turned off, the solenoid is deactivated (out), the green LED is turned off, and the number of times the flaps have been activated by insertion of an item into the chute opening is shown on the display, at step 815, If the “START” button is pressed at step 850, the 2-minute timer flag is set at step 855 and the 2-minute timer is activated at step 860. Thereafter, processing continues at step 720 of FIG. 7. Resetting of the 2-minute timer flag occurs when the bin present sensor detects insertion of a bin (i.e., a replacement bin is detected).

Additional Embodiments and/or Features

Another embodiment of the apparatus 300 includes a magnetic spring-triggered device for detecting bin presence and measuring the bin weight. Based on the bin weight, an indication of the fullness of the bin or the remaining bin capacity can be provided by means of a bar of LED's on the control panel 326.

Yet another embodiment of the apparatus 300 includes an optical sensor subsystem 680 connected to the controller 605 (as shown in FIG. 6) for detecting foreign material, particularly ceramics. Detection is thus automatically performed on glass containers prior to breaking by one or more optical sensors mounted in the upper chute portion of the apparatus 300. A contaminated bin or load of cullet can thus be identified and discarded prior to final beneficiation.

The optical sensor sub-system 680 also enables monitoring of the colour of glass containers inserted through the flaps of the apparatus 300 and the approximate quantity of glass containers per colour category. This information is stored in a data-logger, for providing information relating to:
The total quantity of glass containers processed by the apparatus 300 and the quantity of glass containers of each colour category that are processed.
Contamination of batches/bins of cullet.
Usage of the machine for billing purposes and logistical planning of collection services.
Fault reporting.

Information from the datalogger can be transferred via GSM as an SMS message to a remote computer system for performing quantity and quality control of a waste glass stream.

A her optional feature allows the chisel assembly to be run in a reverse rotational direction for a predetermined period of time. This enables clearing of blockages of the chisels, for example, an object inserted while the chisels are stationary that prevents the chisels from rotating.

Conclusion

Embodiments of a method and an apparatus for processing glass have been described hereinbefore. The embodiments described advantageously reduce the amount of handling and transportation necessary for disposal of glass containers after use and/or improve the quality and consistency of the glass cullet produced. Improved quality and consistency of cullet enables an improved processing rate for the cullet at a beneficiation plant.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

For Australia Only

In the context of this specification, the word “comprising” means “including principally but not necessarily solely” or “having” or “including” and not “consisting only of”. Variations of the word comprising, such as “comprise” and “comprises” have corresponding meanings.

1. An apparatus for processing glass objects, comprising:
a chute assembly with a first opening at one end thereof for receiving said glass objects and a second opening at a distal end thereof for dispensing glass cullet;
a rotatable chisel assembly located substantially transversely within said chute assembly for breaking said glass objects travelling through said chute assembly, wherein said chisel assembly comprises a plurality of blade portions;
drive means for causing said chisel assembly to rotate; and
a controller for controlling said drive means.

2. The apparatus of claim 1, wherein said chisel assembly further comprises at least one protruding portion that extends substantially longitudinally within said chute assembly from said chisel assembly towards said first opening.

3. The apparatus of claim 2, wherein said chisel assembly further comprises a central portion mounted on a shaft disposed substantially longitudinally within said chute assembly, and wherein said blade portions and said at least one protruding portion are mounted on said central portion.

4. The apparatus of claim 3, wherein said protruding portion is mounted substantially midway between said blade portions.

5. The apparatus of claim 4, wherein said central portion comprises an annular collar and a circular disc mounted within said annular collar and wherein said blade portions are mounted circumferentially on said annular collar.

6. The apparatus of claim 5, wherein said at least one protruding portion is mounted on a rim of said annular collar and substantially perpendicularly to said rim.

7. The apparatus of claim 5, wherein said protruding portion is mounted proximate an outer edge of said annular collar.

8. The apparatus of claim 7, further comprising a sweeper portion located on the underside and proximate to the trailing edge of at least one of said blade portions.

9. The apparatus of claim 1, further comprising at least one hinged flap adapted to selectively prevent insertion of objects into said first opening of said chute assembly.

10. The apparatus of claim 1, further comprising a receptacle for receiving said glass cullet from said distal end of said chute assembly.

11. The apparatus of claim 12, further comprising means for detecting when said receptacle is full.

12. The apparatus of claim 13, wherein said means for detecting comprises an ultrasonic detector.

13. The apparatus of claim 1, wherein said controller further controls an average glass cullet size dispensed by said apparatus.

14. The apparatus of claim 13, wherein said controller is adapted to control rotational speed of said chisel assembly.

15. The apparatus of claim 13, wherein said controller is adapted to produce an average glass cullet size of 10 mm to 65 mm.

16. The apparatus of claim 15, wherein said controller is adapted to produce an average glass cullet size of less than 50 mm.

17. The apparatus of claim 1, further comprising an optical detector for detecting objects inserted into said first opening.

18. The apparatus of claim 17, wherein said optical detector is adapted to detect objects including one or more materials selected from the group of material consisting of:
ceramics;
metals;
plastics; and
stones.

19. The apparatus of claim 17, wherein said controller in conjunction with said optical detector is adapted to count the number of objects inserted into said first opening.

20. The apparatus of claim 19, wherein said controller in conjunction with said optical detector is adapted to detect and count the number of glass objects of a particular glass colour inserted into said first opening.

21. An automated method for processing glass objects, said method comprising the steps of:
performing beneficiation to identify foreign matter amongst said glass objects;
breaking said glass objects to produce cullet; and
identifying a portion of said cullet that is free of said foreign matter.

22. The method of claim 21, comprising the further step of transporting said portion of cullet to a central location for further processing.

23. The method of claim 21, wherein each step of said method is performed at a location where said glass containers were used.

24. The method of claim 22, wherein said glass objects are subjected to beneficiation prior to breaking.

25. The method of claim 21, comprising the further step of identifying glass objects of a particular glass colour.

26. An apparatus for processing glass objects, comprising:
means for performing beneficiation to identify foreign matter amongst said glass objects; and
means for breaking said glass objects to produce cullet.

27. The apparatus of claim 26, wherein said means for performing beneficiation to identify foreign matter comprises an optical detector.

28. The apparatus of claim 26, further comprising means for substantially preventing unintentional insertion of foreign matter into said apparatus by an operator.

29. The apparatus of claim 26, wherein said foreign matter comprises one or more materials selected from the group of material consisting of:
ceramics;
metals;
plastics; and
stones.

30. The apparatus of claim 26, further comprising means for identifying glass objects of a particular glass colour.

31. The apparatus of claim 1, further comprising means for substantially preventing unintentional insertion of foreign matter into said apparatus by an operator.

32. The apparatus of claim 31, wherein said means for substantially preventing unintentional insertion of foreign matter comprises at least one iris disposed transversely within said chute assembly.
